(19) United States
(12) Patent Application Publication
(10) Pub. No.: US 2020/0375409 A1
(43) Pub. Date: Dec. 3, 2020

(54) FOOD MIXER

(71) Applicant: ELIYAHU AHARON SHITRIT, GIVAT-ZEEV (IL)

(72) Inventor: ELIYAHU AHARON SHITRIT, GIVAT-ZEEV (IL)

(21) Appl. No.: 16/827,780

(22) Filed: Mar. 24, 2020

Related U.S. Application Data
(60) Provisional application No. 62/853,058, filed on May 27, 2019.

(51) Int. Cl. A47J 47/01; A47J 43/27

(52) U.S. Cl. CPC A47J 47/01; A23L 25/30; A47J 43/27

(57) ABSTRACT

A food mixer, including: a bottom container, for containing raw food, the container including a top opening; a top container, including a bottom outlet and a seal for normally closing the bottom outlet, the top container for disposing thereof above the bottom container, for dispensing water from the top container through the bottom outlet thereof the bottom container through the top opening thereof; at least one compartment, each for containing a spice; and a handle extending from the seal, for lifting the handle for opening the bottom outlet together with opening the at least one compartment.

### CROSS-REFERENCE TO RELATED APPLICATIONS

This application claims the benefit of priority from U.S. Provisional Application No. 62/853,058, filed May 27, 2019, the disclosure of which is incorporated herein by reference.

### TECHNICAL FIELD

The invention relates to the field of tahini preparing.

### BACKGROUND

Tahini is typically prepared inside a bowl or on a plate and generally involves continuous manual mixing by the person preparing it. Frequently, the amount of water added to the Tahini mix is too much causing it to be watery and, as a result, more Tahini has to be added to the mixture. As more Tahini is added to the mixture, more water has to be added to reach the right consistency, and so do more spices and salt. This procedure requires more time and results in a greater undesired amount of Tahini being prepared than originally intended.

The purpose of the present invention is to provide a solution to the abovementioned problems.

### SUMMARY

A food mixer, including:
a bottom container, for containing raw tahini;
a top container, including a bottom outlet and a seal; and
compartment for containing spices; and
a handle for opening the bottom outlet together with opening the compartment.

### BRIEF DESCRIPTION OF THE DRAWINGS

Embodiments, features, and aspects of the invention are described herein in conjunction with the following drawings:

FIG. 1 is a front view of a food mixer according to one embodiment of the invention at the non-assembled state.

FIG. 2 depicts the food mixer of FIG. 1 at the assembled state.

FIG. 3 depicts the food mixer of FIG. 1 at the sixth step.

FIG. 4 depicts the top container of FIG. 1 at the sixth step of FIG. 3, and at the fourth step.

FIG. 5 is the front view of the top container of FIG. 1 at the fourth step of FIG. 4 prior to the sixth step of FIG. 4.

FIG. 6 is a top view of the top container of FIG. 1.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

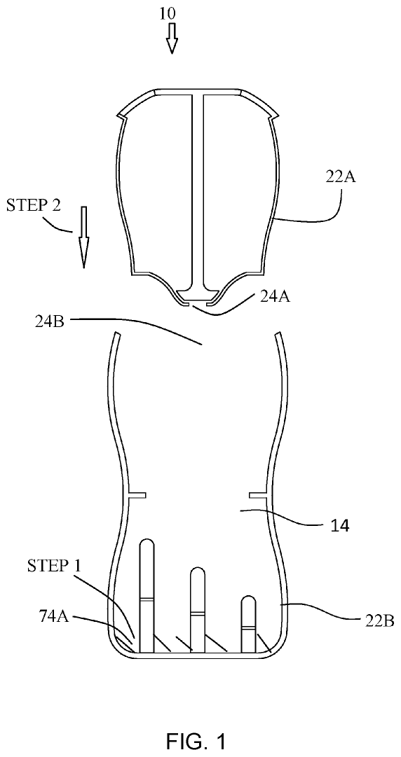

FIG. 1 is a front view of a food mixer according to one embodiment of the invention at the non-assembled state.

A food mixer 10 includes a top container 22A and a bottom container 22B.

At the first step, bottom container 22B contains raw tahini 74A or its is poured thereinto.

At the second step, the user places container 22A on bottom container 22B.

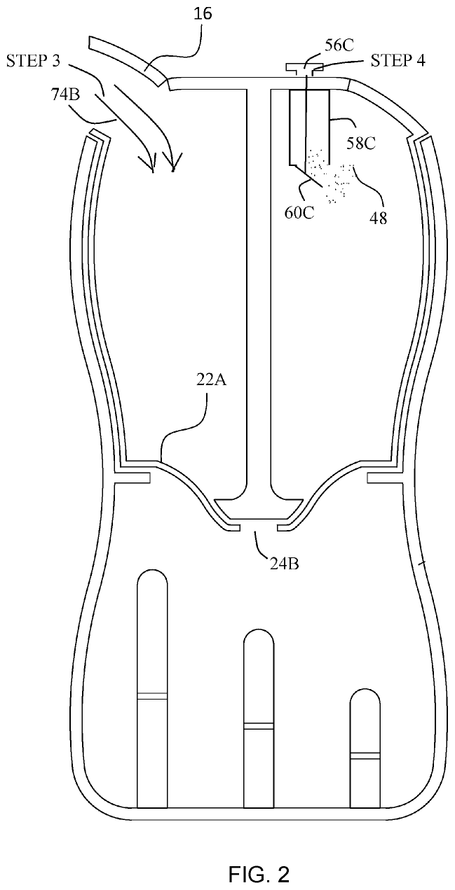

FIG. 2 depicts the food mixer of FIG. 1 at the assembled state.

Top container 22A has a bottom outlet 24A, for dispensing water to bottom container 22B while being assembled.

Top container 22A further includes spices compartments 58C and others, for dispensing spices into the water in bottom container 22B by pressing knob 56C, for opening door 60C.

At the third step, the user pours water 74B into compartment container 22A, which pay pour the spice of compartment 58C.

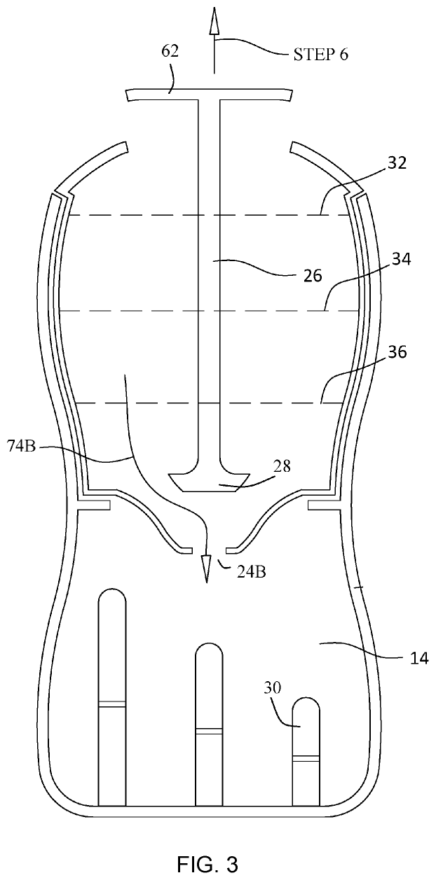

FIG. 3 depicts the food mixer of FIG. 1 at the sixth step.

The fourth and fifth steps are described below. At the sixth step, the user opens bottom outlet 24A of top container 22A by lifting a seal 28 via a handle 62, thereby dispensing water 74B.

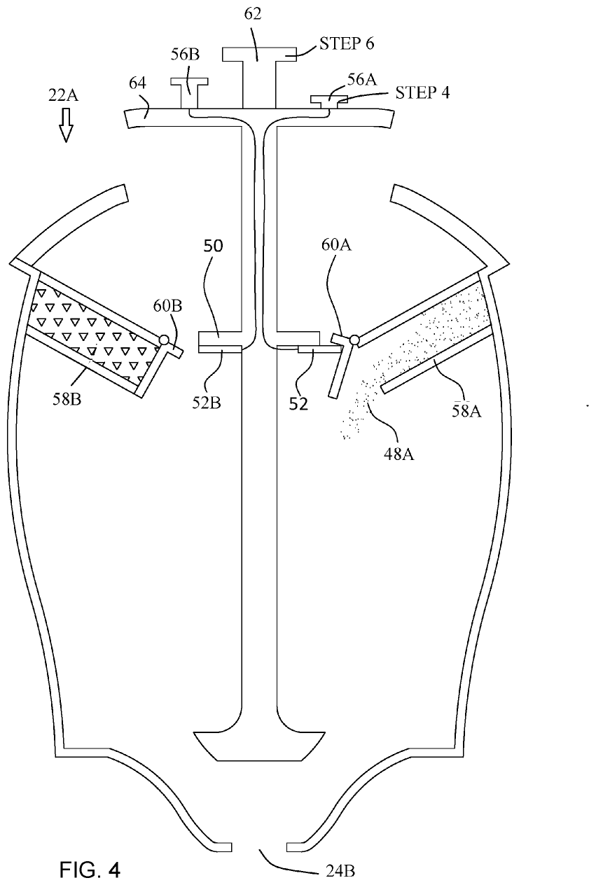

FIG. 4 depicts the top container of FIG. 1 at the sixth step of FIG. 3, and at the fourth step.

Top container 22A may further include spices compartments 58A and 58B, for dispensing spices by the lifting of handle 62 at the sixth step of FIG. 3.

According to the example of FIG. 4, compartment 58A opens a door 60A thereof, thus dispenses upon lifting handle 62 at the sixth step, since a knob 56A has been previously pressed at the fourth step.

According to the example of FIG. 4, compartment 58B does not open a door 60B thereof, thus does not dispense upon lifting handle 62 at the sixth step, since a knob 56B has not been previously pressed at the fourth step.

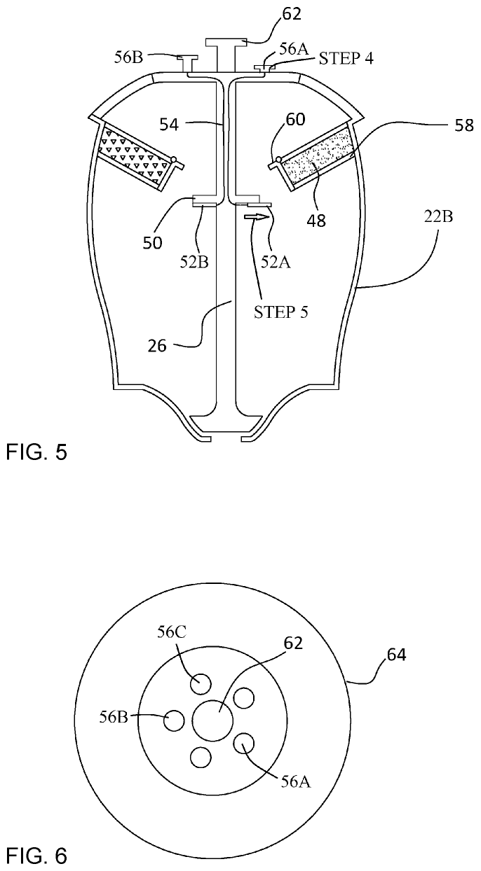

FIG. 5 is the front view of the top container of FIG. 1 at the fourth step of FIG. 4 prior to the sixth step of FIG. 4.

Pressing of knob 56A downwards at the fourth step, slides at the fifth step a protrusion 52A via a Bowden cable 54.

Referring again to FIG. 4, protrusion 52A being protruded is lifted by handle 62, thus rotates door 60A by the lifting of handle 62. In contrast, protrusion 52B not being protruded does not rotate door 60B by being lifted by the lifting of handle 62.

FIG. 6 is a top view of the top container of FIG. 1.

For example, for dispensing only spice of the five compartments, only knob 56A is to be pressed.

According to another structure, for dispensing four spices of the five compartments, only knob 56A is to be pressed.

Thus, in one aspect, the invention is directed to a tahini (food to be mixed) mixer (10), including:
a bottom container (22B), for containing raw tahini, the bottom container (22B) including a top opening (24B);
a top container (22A), including a bottom outlet (24A) and a seal (28) for normally closing the bottom outlet (24A), the top container for disposing thereof above the bottom container (22B), for dispensing water from the top container (22A) through the bottom outlet (24A) thereof the bottom container (22B) through the top opening (24B) thereof; and
at least one compartment (58A), each for containing a spice (48);
a handle (62) extending from the seal (28), for lifting the handle (62) for opening the bottom outlet (24A) together with opening the at least one compartment (58A), thereby the lifting of the handle (62) dispenses the water (74B) and the at least one spice (48) into the bottom container (22A), and
lowering of the handle (62) closes the bottom container (22A), for allowing shaking the raw tahini, the water and the at least one spice (48) altogether for mixing thereof.

The food mixer (10) may further include:
a knob, for each of the at least one compartment (58A), for controlling the opening thereof by the lifting of the handle (62),
thereby allowing selecting spices to be dispensed by the lifting of the handle (62).

The food mixer (10) may further include:

The top container (22A) may further include a slidable protrusion (52A,52B) for each of the at least one compartment (58A), being configured to open a door (60A) of that compartment (58A) by the lifting of the handle (62) at a slided state thereof.

In the figures and/or description herein, the following reference numerals (Reference Signs List) have been mentioned:

numeral 10 denotes the food mixer according to one embodiment of the invention;
14: space;
16: water opening;
22A: top container;
22B: bottom container;
24A: bottom outlet of top container 22A;
24B: top opening of bottom container 22B;
26: rod;
30: level mark;
32,34,36: available amounts of water;
48: spice;
50: peripheral extension, extending from rod 26, for sliding slidable protrusions 52A,52B, etc. therealong;
52A,52B: slidable protrusions;
54: Bowden cable;
56A,56B,56C: knobs;
58A,58B: compartments;
62: handle;
64: plate;
74A: raw tahini;
74B: water.

The foregoing description and illustrations of the embodiments of the invention have been presented for the purpose of illustration, and are not intended to be exhaustive or to limit the invention to the above description in any form. Any term that has been defined above and used in the claims, should be interpreted according to this definition. The reference numbers in the claims are not a part of the claims, but rather used for facilitating the reading thereof. These reference numbers should not be interpreted as limiting the claims in any form.

What is claimed is:

1. A food mixer, comprising:
a bottom container, for containing raw food, said container comprising a top opening;
a top container, comprising a bottom outlet and a seal for normally closing said bottom outlet, said top container for disposing thereof above said bottom container, for dispensing water from said top container through said bottom outlet thereof, to said bottom container through said top opening thereof;
at least one compartment, each for containing a spice; and
a handle extending from said seal, for lifting said handle for opening said bottom outlet,
thereby said lifting of said handle dispenses said water and said at least one spice into said bottom container, and
lowering of said handle closes said bottom container, for allowing shaking said raw food, said water and said at least one spice altogether for mixing thereof.

2. A food mixer according to claim 1, wherein together with said handle is configured to open said at least one compartment.

3. The food mixer according to claim 2, further comprising:
a knob, for each of said at least one compartment, for controlling said opening thereof by said lifting of said handle.

4. The food mixer according to claim 2, further comprising:
a knob, for each of said at least one compartment, for allowing said opening thereof by said lifting of said handle,
thereby allowing selecting spices to be dispensed by said lifting of said handle.

5. The food mixer according to claim 2, further comprising:
a knob, for each of said at least one compartment, for allowing said opening thereof by said lifting of said handle,
thereby allowing selecting spices to be dispensed by said lifting of said handle.

6. The food mixer according to claim 2, wherein said top container further comprises a slidable protrusion for each of said at least one compartment, being configured to open a door of that compartment by said lifting of said handle at a slided state thereof.
